(19) United States
(12) Patent Application Publication
(10) Pub. No.: US 2015/0334512 A1
(43) Pub. Date: Nov. 19, 2015

(54) NEAR FIELD COMMUNICATION SYSTEM

(71) Applicants: Donald GONZALEZ, Cupertino, CA (US); Steven L. TRAVIS, (US); HEWLET-PACKARD DEVELOPMENT COMPANY, L.P., Houston, TX (US)

(72) Inventors: Donald Gonzalez, Palo Alto, CA (US); Steven L. Travis, Ft. Collins, CO (US)

(73) Assignee: Hewlett-Packard Development Company, LP., Houston, TX (US)

(21) Appl. No.: 14/431,296

(22) PCT Filed: Nov. 6, 2012
(86) PCT No.: PCT/US2012/063642

§ 371 Date: Mar. 25, 2015

(51) Int. Cl. H04W 4/00; H04B 5/00; H04W 12/06

(52) U.S. Cl. CPC H04W 4/008; H04W 12/06; H04B 5/0031

(57) ABSTRACT

A near field communication device including a processor to receive a near field communication from a near field communication tag, where the near field communication tag is associated with a script. The processor interprets the communication to obtain the script, and executes the script to automatically perform one or more tasks.

### BACKGROUND

Consumers appreciate ease of use in their devices. They also appreciate the ability to update their devices with new features and/or functionality. Designers and manufacturers may, therefore, endeavor to create or build devices directed toward one or more of these objectives.

### BRIEF DESCRIPTION OF THE DRAWINGS

The following detailed description references the drawings, wherein:

FIG. 1 is an example of a near field communication system.

FIG. 2 is another example of a near field communication system.

FIG. 3 illustrates examples of various types of technologies that may be used as a communication channel.

FIG. 4 is an illustration of an example of a non-volatile storage medium.

FIG. 5 is an illustration of an example of additional instructions on the non-volatile storage medium of FIG. 4.

FIG. 6 is an illustration of an example of a method of near field communication.

FIG. 7 is an illustration of art example of additional elements of the method of FIG. 6.

### DETAILED DESCRIPTION

Near field communications (NFC) is expected to become ubiquitous on devices, such as computers, smart or mobile phones, and tablets, in the near future. Singular or single-use near field communication solutions are predetermined for a specific purpose. A general use model is a near field communication device that receives a “tap” from a near filed communication tag. The near field communication device then receives a transfer of data or other information as a result of the “tap” from the near field communication tag. As an example, a smart or mobile phone designed for use as an authentication or authorization NFC tag is used to conduct a financial transaction or to work. as an identity token when the user taps the phone to a point of sale device.

An issue arises, however, when today's consumers desire features and/or functionality that was not included in devices previously configured and sold. These devices are locked into their original intended use and cannot be adapted to such future demands unless the hardware and/or software of such devices are updated. This limited purpose of current near filed communication solutions is seen as a restriction that provides an opportunity for innovation.

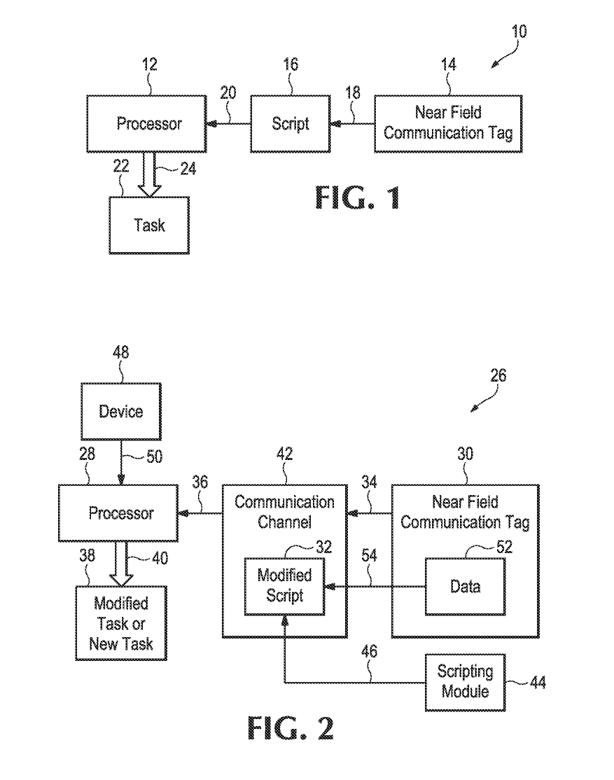

A near field communication system 10 directed to addressing these challenges is illustrated in FIG. 1. As used herein, the term “near field communication” and “NFC” are defined as including, but not necessarily being limited to, a technology for devices to establish communication with each other by touching them together or bringing them into close proximity (e.g., a distance of approximately four (4) centimeters (cm) or less). This communication can be encrypted or unencrypted. This communication may also be established over radio frequencies (e.g., 13.56 megahertz (MHz) on an ISO/IEC 18000-3 air interface) and at varying data rates (e.g., 106 Kbits/sec. to 424 Kbits/sec). Near field communication devices can engage in twp-way way communication with one another, as well as one-way communication with near field communication data tags. Portions of near field communication technology have been approved as standards (e.g., ISO/IEC 18092/ECMA-340 and ISO/IEC 21481/ECMA-352).

As used herein, the term “near field communication data tag”, “near field communication tag”, “NEC data tag”, and “NEC tag” are defined as including, but not necessarily being limited to, a near field communication device that contains or stores one or more scripts and/or data. These scripts and/or data may be read-only or rewriteable. Examples of near field communication data tags include, but are not necessarily limited to, tickets, tokens, information signs or placards, passes, currency, or storage devices containing data formatted to a data tag specification.

Devices using near field communication may he active or passive. A passive NEC device, such as an NFC data tag, contains information that other devices can read, but does not read any information itself. Active devices can read information, as well as send it. An active NFC device, is not only able to collect information from an NFC tag, but also able to exchange information and data with other active NEC devices. An active NEC device can even alter scripts, information and/or data on a passive NFC device, if authorized to make such changes.

As used herein, the term “non-volatile storage medium” is defined as including, but not necessarily being limited to, any media that can contain, store, or maintain programs, scripts, information, and data. A non-volatile storage medium may include any one of many physical media such as, for example, electronic, magnetic, optical, electromagnetic, or semiconductor media. More specific examples of suitable a non-volatile storage media include, but are not limited to, a magnetic computer diskette such as floppy diskettes cir hard drives, magnetic tape, a random access memory (RAM) a read-only memory (ROM), an erasable programmable read-only memory (EPROM), a flash drive, a compact disc (CD), or a digital video disk (DVD).

As used herein, the term “processor” is defined as including, but not necessarily being limited to an instruction execution system such as a computer/processor based system, an Application Specific Integrated Circuit (ASIC), a computing device, or a hardware and/or software system that can fetch or obtain the logic from a non-volatile storage medium and execute the instructions contained therein. “Processor” can also include any controller, state-machine, microprocessor, cloud-based utility, service or feature, or any other analogue, digital and/or mechanical implementation thereof.

As used herein, “device”, “near field communication device” and “NFC device” are defined as including, but not necessarily being limited to, a computer, server, a smart or mobile phone, a tablet, computing device, personal digital assistant, peripheral or other similar device. As used herein, “automatic” or “automatically” are defined as including, but not necessarily being limited to, an action, process, function, task, operation, work, or procedure that is performed, executed, or otherwise carried out independent of or without requiring action, input, or effort on the part of a user of a device, such as a near field communication device, or a near field communication system.

As used herein, “script” is defined as including, but not necessarily being limited to, a program, macro, or set of instructions operating or executing in software, firmware, and/or hardware for automating the execution of a task or tasks which could alternatively be completed by a human operator, person or computer application. As used herein, “scripting module” or “scripting language” are defined as including, but not necessarily being limited to, a program, code, or set of instructions operating or executing in software, firmware, and/or hardware that supports the writing, creating, and or generation of one or more scripts.

As used herein, “communication channel” is defined as including, but not necessarily being limited to a link or connection by which one or more scripts, data, commands, and/or information are or can be transmitted. Examples of a communication channel include, but are not necessarily limited to, radio frequency transmission, the internet, an intranet, the cloud, a cloud-based facility, infra-red transmission, photonics, electromagnetic, and/or a physical connection.

Referring again to FIG. 1, near filed communication system 10 includes a processor 12 to receive near field communication and to interpret such received communication. Near field communication system 10 also includes a near field communication tag 14 that initiates transmission of a script 16, as generally indicated by arrow 18, for receipt by processor 12, as generally indicated by arrow 20. Script 16 is interpreted by processor 12 as a set of instructions that, when executed by processor 12, causes processor 12 to automatically perform a task 22 independent of action of a user of near field communication system 10, as generally indicated by arrow 24.

Task 22 may be one or more operations or commands that a device performs such as, for example, sending an e-mail, remote logon, launching an application, displaying information, completing a transaction, etc. Script 16 may be partially or completely stored on near field communication tag 14 for transmission to processor 12 via a communication channel Alternatively or additionally, script 16 may be partially or completely obtained elsewhere (e.g., remote server or storage) via a communication channel.

Another example of a near field communication system 26 is shown in FIG. 2. As can be seen in FIG. 2, near field communication system 26 includes a processor 28 to receive near field communication and to interpret such received communication. Near field communication system 26 also includes a near field communication tag 30 that initiates transmission of a modified script 32, as generally indicated by arrow 34, for receipt by processor 28, as generally indicated by arrow 36. Modified script 32 is interpreted by processor 28 as either a modified set of instructions or a new set of instructions that, when executed by processor 28, causes processor 28 to automatically perform a modified or new task 38 independent of action of a user of near field communication system 26, as generally indicated by arrow 40.

Modified or new task 38 may be one or more operations or commands that a device performs such as, for example, sending an e-mail, remote logon, launching an application, displaying information, completing a transaction, etc. Modified script 32 may be partially or completely stored on near field communication tag 30 for transmission to processor 28 via communication channel 42. Alternatively or additionally, modified script 32 may be partially or completely obtained elsewhere (e.g., remote server or storage) via communication channel 42.

As can also be seen in FIG. 2, near field communication system 26 may include a scripting module 44 to modify script 32 associated with near field communication tag 30, as generally indicated by arrow 46. Scripting module 44 may also be used to create a new script for execution by processor 28. As can additionally be seen in FIG. 2, near filed communication system 26 may also include a device 48 coupled to processor 28, as generally indicated by arrow 50.

As can further be seen in FIG. 2, near field communication tag 30 may also initiate transmission of data or information 52 via communication channel 42, as generally indicated by arrow 54. Data or information 52 may be partially or completely stored on near field communication tag 30 for transmission to processor 28 via communication channel 42. Alternatively or additionally, data or information 52 may be partially or completely obtained elsewhere (e.g., remote server or storage) via communication channel 42.

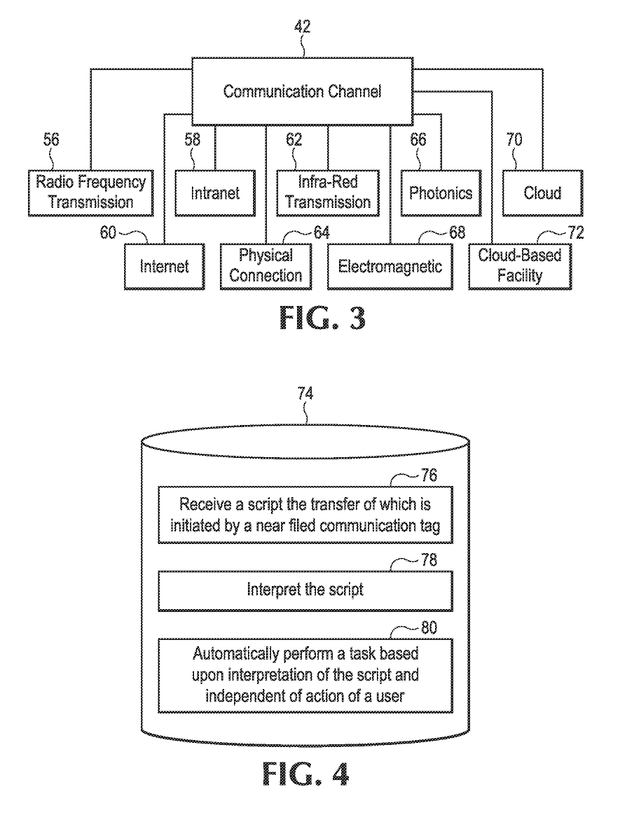

Examples of various types of technologies that may be used by communication channel 42 are shown in FIG. 3. These various types of technologies may be used alone or in one or more combinations with each other. Communication channel may be used in any number of examples of near field communication systems, including system 10 illustrated in FIG. 1 and system 26 illustrated in FIG. 2.

As can be seen in FIG. 3, communication channel 42 may include radio frequency transmission 56, an intranet 58, the internet 60, an infra-red transmission 62, and/or a physical connection (e.g., USB, SCSI, PCMCIA, I²C, etc.). Alternatively or additionally, communication channel 42 may include photonics 66, electromagnetic transmission 68, the cloud 70, and/or a cloud-based facility 72.

An illustration of an example of a non-volatile storage medium 74 is shown in FIG. 4. Non-volatile storage medium 74 includes instructions that, when executed by a processor, such as processor 12 or processor 28, cause the processor to receive a script, such as script 16, the transfer of which is initiated by a near filed communication tag, such as tag 14, as indicated by block 76. As can also be seen in FIG. 4, non-volatile storage medium 74 includes additional instructions that, when executed by the processor, cause the processor to interpret the script, as indicted by block 78, and automatically perform a task, such as task 22, based upon interpretation of the script and independent of action of a user, as indicated by block 80.

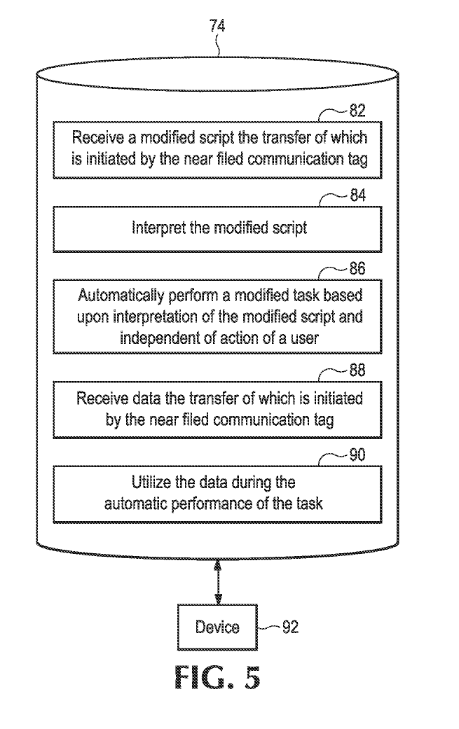

An illustration of an example of additional instructions that may be on non-volatile storage medium 74 is shown in FIG. 5. As can be seen in FIG. 5, non-volatile storage medium 74 may include additional instructions that, when executed by the processor, cause the processor to receive a modified script, such as modified script 32, the transfer of which is initiated by the near filed communication tag, as indicated by block 82. As can also be seen in FIG. 5, non-volatile storage medium 74 may include additional instructions that, when executed by the processor, cause the processor to interpret the modified script, as indicated by block 84, and automatically perform a modified task, such as modified task 38, based upon interpretation of the modified script and independent of action of a user, as indicated by block 86.

Alternatively or additionally, non-volatile storage medium 74 may include additional instructions that, when executed by the processor, cause the processor to receive data, such as data 52, the transfer of which is initiated by the near filed communication tag, as indicated by block 88, and utilize the data during the automatic performance of the task, as indicated by block 90. Non-volatile storage medium 74 may be in a near field communication device, as generally indicated block.

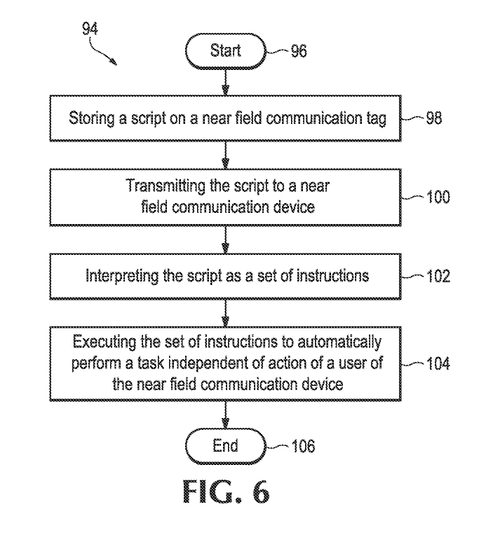

An illustration of an example of a method of near field communication 94 is shown in FIG. 6. As can be seen in FIG. 6, method 94 starts or begins 96 by storing a script on a near field communication tag, as indicated by block 98, and transmitting the script to a near field communication device, as indicated by block 100. Method 94 continues by interpreting the script as a set of instructions, as indicated by block 102, and executing the set of instructions to automatically perform a task independent of action of a user of the near field communication device, as indicated by block 104. Method 94 may then end 106.

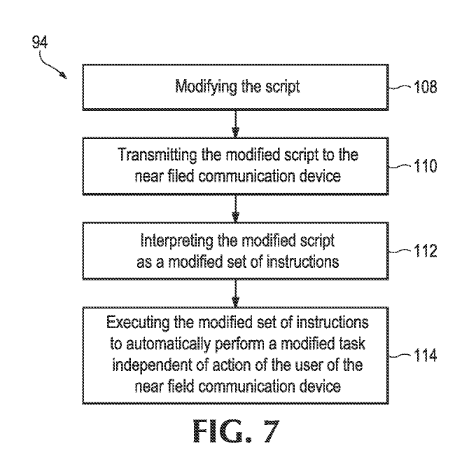

An illustration of an example of additional possible elements of method of near field communication 94 is shown in FIG. 7. As can be seen in FIG. 7, method 94 may additionally include modifying the script, as indicated by block 108, and transmitting the modified script to the near filed communication device, as indicated by block 110. Method 94 may continue by interpreting the modified script as a modified set of instructions, as indicated by block 112, and executing the modified set of instructions to automatically perform a modified task independent of action of the user of the near field communication device, as indicated by block 114.

From the forgoing description, it can be seen that by providing a scripting language that is communicated to a device through a near field communication tag, the device can not only receive data (e.g., authentication and authorization tokens), but also execute one or more tasks, for example to produce a multiple of outcomes. An advantage of this scripting solution is that the purpose of a near field communication device does not need to be predetermined at NFC system configuration time. Additionally, the complexity and configurability of tasks can be increased.

Although several examples have been described and illustrated in detail, it is to be clearly understood that the same are intended by way of illustration and example only. These examples are not intended to be exhaustive or to limit the invention to the precise form or to the exemplary embodiments disclosed. Modifications and variations may well be apparent to those of ordinary skill in the art. The spirit and scope of the present invention are to be limited only by the terms of the following claims.

Additional reference to an element in the singular is not intended to mean one and only one, unless explicitly so stated, but rather means one or more. Moreover, no element or component is intended to be dedicated to the public regardless of whether the element or component is explicitly recited in the following claims.

1. A near field communication device, comprising:
a processor to:
receive a near field communication from a near field communication tag, the near field communication tag being associated with a script;
interpret the communication to obtain the script; and
execute the script to automatically perform one or more tasks.

2-15. (canceled)

16. The near field communication device of claim 1, wherein the processor obtains the script from a memory of the near field communication tag.

17. The near field communication device of claim 1, further comprising:
a storage that stores at least a portion of the script; and
wherein the processor obtains at least a portion of the script from the storage.

18. The near field communication device of claim 1, wherein the processor is initiated by the near field communication to use a communication channel to obtain at least a portion of the script from a remote source.

19. The near field communication device of claim 1, wherein the processor executes the script to produce multiple outcomes using one or more applications that resides on the near field communication device of claim 1.

20. The near field communication device of claim 1, wherein the processor receives a data element from the near field communication, and uses the data element with an application of the near field communication device in order to automatically perform the one or more tasks.

21. The near field communication device of claim 20, wherein the data element corresponds to one or more of an authentication token, an authorization token, a ticket, an information sign, a security pass, or a currency.

22. The near field communication device of claim 1, wherein the processor performs one or more tasks that include at least one of (i) sending an e-mail, (ii) performing a remote login, (iii) launching an application, (iv) displaying information, or (v) completing a transaction.

23. The near field communication device of claim 1, wherein the near field communication device is implemented as a mobile computing device that taps a device of the near field communication tag in order to obtain the near field communication.

24. The near field communication device of claim 1, wherein the near field communication in encrypted.

25. The near field communication device of claim 1, further comprising a scripting module which modifies the script provided by the near field communication tag for execution by the processor.

26. The near field communication device of claim 25, wherein the processor executes the modified script to perform a modified task as compared to a task that would otherwise be executed by the script without being modified.

27. A near field communication device comprising:
a memory to store data and information; and
a near field communication tag to transmit the data and information to a second near field communication device, the data and information causing a processor of the second near field communication device to execute a script that is associated with the near field communication tag.

28. The near field communication device of claim 27, wherein the data and information includes at least some instructions of the script.

29. The near field communication device of claim 28, wherein the data and information includes at least one of an authorization or authentication token.

30. The near field communication device of claim 27, wherein the near field communication device is passive.

31. The near field communication device of claim 27, wherein the near field communication device is active, and further comprises a processor to implement a scripting module.

32. The near field communication device of claim 31, wherein the memory stores the script, and wherein the scripting module is implemented by the processor of the near field communication device in order to modify the script before the modified script is transmitted to the second near field communication device using the near field communication tag.

33. A method for operating a near field communication device, the method comprising:
receiving a near field communication from a near field communication tag, the near field communication tag being associated with a script;
interpreting the communication to obtain the script; and
executing the script to automatically perform one or more tasks independent of action of a user of the communication device.

34. The method of claim 33, wherein executing the script includes automatically performing one or more tasks that include at least one of (i) sending an e-mail, (ii) performing a remote login, (iii) launching an application, (iv) displaying information, or (v) completing a transaction.

35. The method of claim 33, further comprising obtaining at least a portion of the script from either storage on the near field communication device or a remote source.
